(19) United States
(12) Patent Application Publication
(10) Pub. No.: US 2021/0268843 A1
(43) Pub. Date: Sep. 2, 2021

(54) Pneumatic Tire

(71) Applicant: The Yokohama Rubber Co., LTD., Minato-ku, Tokyo (JP)

(72) Inventor: Tatsuro Shinzawa, Hiratsuka-shi, Kanagawa (JP)

(21) Appl. No.: 17/254,247

(22) PCT Filed: May 29, 2019
(86) PCT No.: PCT/JP2019/021181

§ 371 Date: Dec. 18, 2020

(30) Foreign Application Priority Data
Jun. 18, 2018 (JP) 2018-115378

(51) Int. Cl. B60C 13/00; B60C 1/00; C08L 9/02; C08L 9/06; C08L 7/00

(52) U.S. Cl. CPC B60C 13/001; B60C 1/0025; C08L 7/00; C08L 9/06; C08L 9/02

(57) ABSTRACT

A pneumatic tire includes sidewall portions that sandwich, from both sides in a width direction, a tread portion extending in a circumferential direction and forms an annular shape. A two-dimensional code, in which a dot pattern is formed using two types of light and shade elements using recesses and protrusions such that the light and shade elements are distinguished from each other, is engraved on a surface of a side rubber member of the sidewall portion. The side rubber member is formed from a rubber component and an anti-aging agent. 2.7 D<W<9 D is satisfied, in which a recess depth of a recess portion among the recesses and protrusions so as to form shade elements of the light and shade elements is D mm, and a blending amount of the anti-aging agent with respect to 100 parts by mass of the rubber component is W parts by mass.

### TECHNICAL FIELD

The present technology relates to a pneumatic tire and particularly relates to a pneumatic tire including a two-dimensional code engraved on a sidewall portion of the tire.

### BACKGROUND ART

In the related art, a known pneumatic tire (hereinafter referred to simply as a tire) is provided with, in a sidewall portion, a two-dimensional code in which information is recorded. The two-dimensional code can include more information than a one-dimensional code. Thus, various information can be included in the two-dimensional code for management of the tire. Particularly, a technique of engraving a predetermined dot hole pattern on a side surface portion (sidewall portion) of a tire to form a two-dimensional code composed of a light and shade element pattern on the side surface portion of the tire has been proposed (see International Patent Publication No. WO 2005/000714).

Since the two-dimensional code formed by engraving a predetermined dot hole pattern on the side surface portion of the tire does not disappear unless the side surface portion of the tire is worn, the tire can be managed effectively.

In a pneumatic tire provided with a plurality of dot holes by engraving such a two-dimensional code, the two-dimensional code can be sufficiently read while the tire is new. However, in a case where the tire rolls for a long period in an outdoor and high-temperature environment, the readability of the two-dimensional code may decrease. “Reading of a two-dimensional code” refers to reading of a two-dimensional code by a two-dimensional code reader (for example, a mobile terminal), and “decreased readability” refers to an increased frequency of failures in reading.

By the way, additives such as anti-aging agents and waxes are generally blended into a side rubber member of the sidewall portion in order to prevent deterioration and cracking of the rubber member due to exposure to ultraviolet light and an oxygen atmosphere. The anti-aging agent or wax forms a film that blooms on the surface of the sidewall portion to cover the surface, and suppresses deterioration of the rubber due to ultraviolet light or an oxygen atmosphere.

However, the anti-aging agent or wax blooming on the sidewall surface is susceptible to discoloration or degeneration over time, which may make it difficult to distinguish the light and shade elements of the two-dimensional code. Therefore, there is a risk that the readability of the two-dimensional code may decrease.

### SUMMARY

The present technology provides a pneumatic tire capable of suppressing a decrease in readability of a two-dimensional code while suppressing an occurrence of cracks in the two-dimensional code.

An aspect of the present technology provides a pneumatic tire including:

a pair of sidewall portions that sandwich a tread portion from both sides in a tire width direction, the tread portion extending in a tire circumferential direction and forming an annular shape,

a two-dimensional code, in which a dot pattern is formed using two types of light and shade elements that are formed by recesses and protrusions such that the light and shade elements can be distinguished from each other, being engraved on a surface of a side rubber member of the pair of sidewall portions,

the side rubber member being formed from a rubber material containing a rubber component and an anti-aging agent, and

2.7 D<W<9 D being satisfied, in which a recess depth of a recess portion among the recesses and protrusions formed on the surface of the side rubber member so as to form shade elements of the light and shade elements is D mm, and a blending amount of the anti-aging agent with respect to 100 parts by mass of the rubber component is W parts by mass.

Preferably, the rubber material contains a wax, and 0.6 D<X<3D is satisfied, in which a blending amount of the wax with respect to 100 parts by mass of the rubber component is X parts by mass.

Another aspect of the present technology provides a pneumatic tire including:

a pair of sidewall portions that sandwich a tread portion from both sides in a tire width direction, the tread portion extending in a tire circumferential direction and forming an annular shape,

a two-dimensional code, in which a dot pattern is formed using two types of light and shade elements that are formed by recesses and protrusions such that the light and shade elements can be distinguished from each other, being engraved on a surface of a side rubber member of the pair of sidewall portions,

the side rubber member being formed from a rubber material containing a rubber component and a wax, and

0.6 D<X<3D being satisfied, in which a recess depth of a recess portion among the recesses and protrusions formed on the surface of the side rubber member so as to form shade elements of the light and shade elements is D mm, and a blending amount of the wax with respect to 100 parts by mass of the rubber component is X parts by mass.

Preferably, the wax includes a first wax component and a second wax component each including a plurality of components having different carbon numbers,

a carbon number of a component having a highest content among the components of the first wax component is less than 40,

a carbon number of a component having a highest content among the components of the second wax component exceeds 40, and

(XU/XL)×D is from 0.3 to 2.6, in which a blending amount of the first wax component with respect to 100 parts by mass of the rubber component is XL parts by mass, and a blending amount of the second wax component with respect to 100 parts by mass of the rubber component is XU parts by mass.

Preferably, a content XL of the first wax component is larger than a content XU of the second wax component.

Preferably, the rubber material further contains an anti-aging agent, and

2.7 D<W<9 D is satisfied, in which a blending amount of the anti-aging agent with respect to 100 parts by mass of the rubber component is W parts by mass.

Preferably, the recess depth is from 0.8 to 1.0 mm.

Preferably, an opening length at an opening end of the recess portion open to the surface of the side rubber member is from 0.1 to 1.0 mm.

Preferably, in the pneumatic tire of the two aspects, the two-dimensional code is provided closer to a bead core side of the pneumatic tire than a position in the tire radial direction where the tire width is the largest.

According to the pneumatic tire of the above-described aspects, it is possible to suppress a decrease in readability of a two-dimensional code while suppressing an occurrence of cracks in the two-dimensional code.

### BRIEF DESCRIPTION OF DRAWINGS

FIG. 1 is a diagram illustrating an example of a configuration of a pneumatic tire of an embodiment.

FIGS. 2A and 2B are diagrams illustrating an example of a two-dimensional code according to one embodiment.

### DETAILED DESCRIPTION

Hereinafter, a pneumatic tire of the present embodiment will be described in detail. The present embodiment includes the first and second embodiments described later, and each of the first and second embodiments includes various embodiments described later.

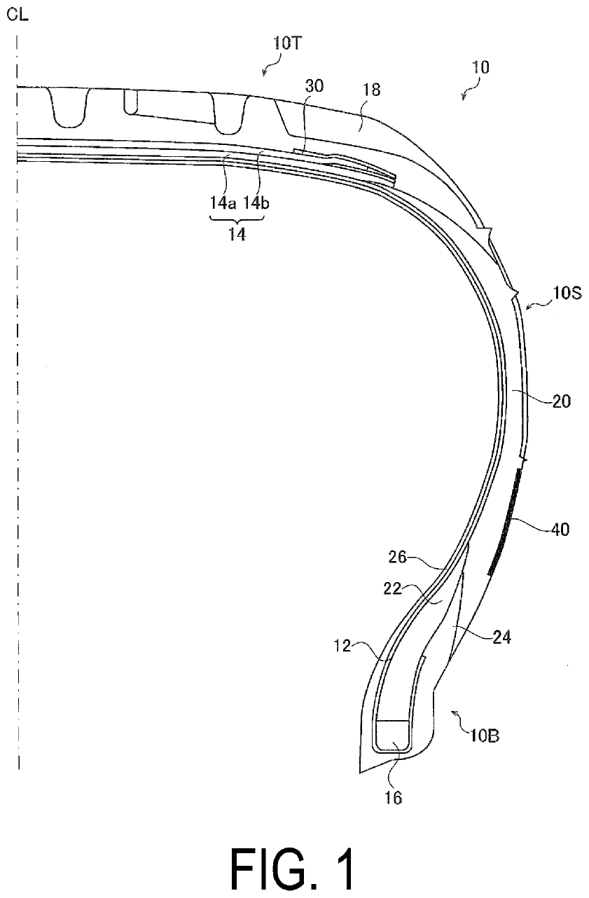

In the present specification, “tire width direction” is the direction parallel with the rotation axis of the pneumatic tire. An outer side in the tire width direction is a side in the tire width direction away from a tire equator line CL (see FIG. 1) that represents the tire equatorial plane. An inner side in the tire width direction is a side in the tire width direction toward the tire equator line CL. A tire circumferential direction is a direction of rotation of the pneumatic tire about the center of the rotation axis. A tire radial direction is the direction orthogonal to the rotation axis of the pneumatic tire. An outer side in the tire radial direction is a side away from the rotation axis. Similarly, an inner side in the tire radial direction is a side closer to the rotation axis.

The engraving referred to in the present embodiment includes a case in which a laser beam is focused on a surface of a sidewall portion 10S so that energy concentrates on the surface to locally heat and burn a side rubber member 20 to form a plurality of minute dot holes on the surface and a case in which an information recording code is formed by engraving irregularities on the surface of the side rubber member.

The two-dimensional code referred to in the present embodiment is a matrix display-type code including information in two directions compared to a one-dimensional code (bar code) including information in the lateral direction only. Examples of the two-dimensional code include a QR Code® (registered trade name), a data matrix (registered trade name), Maxicode, PDF-417 (registered trade name), 16K code (registered trade name), 49 code (registered trade name), an Aztec code (registered trade name), an SP code (registered trade name), a Vericode® (registered trade name), and a CP code (registered trade name).

### Pneumatic Tire

FIG. 1 is a diagram illustrating an example of a configuration of a pneumatic tire (hereinafter referred to as a “tire”) 10 of the present embodiment. FIG. 1 illustrates a profile cross section of one side in the tire width direction with respect to the tire equator line CL.

The tire 10 includes a tread portion 10T including a tread pattern, a pair of bead portions 10B on the respective sides in the tire width direction, and a pair of sidewall portions 10S provided on the respective sides of the tread portion 10T and connected to the pair of bead portions 10B and the tread portion 10T. The tread portion 10T comes into contact with a road surface. The sidewall portions 10S sandwich the tread portion 10T from both sides in the tire width direction. The bead portion 10B is a portion which is connected to the sidewall portion 10S and is located at the inner side of the sidewall portion 10S in the tire radial direction.

The tire 10 includes a carcass ply 12, a belt 14, and a bead core 16 as framework members, and mainly include a tread rubber member 18, side rubber members 20, bead filler rubber members 22, rim cushion rubber members 24, and an innerliner rubber member 26 around the framework members.

The carcass ply 12 includes a carcass ply member that is made of organic fibers covered with rubber and that is wound between a pair of annular bead cores 16 and formed into a toroidal shape. The carcass ply material is wound around the bead cores 16 and extends toward the outer side in the tire radial direction. The belt 14 is provided at the outer side of the carcass ply 12 in the tire radial direction and includes two belt members 14a and 14b. The belt 14 includes a member of rubber-covered steel cords arranged at a predetermined inclination angle of, for example, from 20 to 30 degrees with respect to the tire circumferential direction. A lower layer belt member 14a has a greater width in the tire width direction than an upper layer belt member 14b. The steel cords of the two belt members 14a and 14b are inclined in opposite directions. As such, the belt members 14a and 14b are crossing layers serving to suppress expansion of the carcass ply 12 due to the pressure of the air in the tire.

The tread rubber member 18 is provided at the outer side of the belt 14 in the tire radial direction. Both end portions of the tread rubber member 18 are respectively connected to the side rubber members 20 to form the sidewall portions. The rim cushion rubber members 24 are respectively provided at the inner ends of the side rubber members 20 in the tire radial direction and come into contact with a rim on which the tire 10 is mounted. The bead filler rubber member 22 is provided at the outer side of the bead cores 16 in the tire radial direction and is interposed between a portion of the carcass ply 12 that has not been wound around the bead core 16 and a portion of the carcass ply 12 that has been wound around the bead core 16. The innerliner rubber member 26 is provided on the inner surface of the tire 10 facing a tire cavity region that is filled with air and is surrounded by the tire 10 and the rim.

Besides this, a belt cover 30 formed from organic fiber covered with rubber is provided between the belt member 14b and the tread rubber member 18 so as to cover both ends of the belt 14 in the tire width direction from the outer side in the tire radial direction of the belt 14. The belt cover 30 may be provided as needed and is not mandatory. In the example illustrated in FIG. 1, the belt covers 30 are disposed at intervals so as to cover both ends of the belt 14 in the tire width direction. However, instead of or alternatively to such belt covers 30, another belt cover may be disposed on the inner side in the tire radial direction of the belt cover 30 so as to cover the entire region of the belt 14 in the tire width direction. The number of layers of the belt covers 30 is not limited to one and may be two or three layers.

A two-dimensional code 40 is provided on the surface of the sidewall portion 10S of the tire 10 as described above. In FIG. 1, the arrangement position of the two-dimensional code 40 is indicated by a thick line.

### Two-dimensional Code

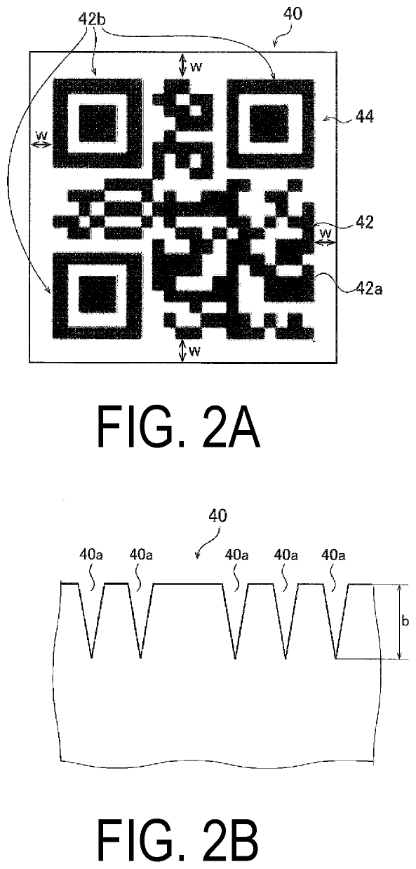

FIGS. 2A and 2B are diagrams illustrating an example of the two-dimensional code 40 according to an embodiment.

The two-dimensional code 40 is engraved on the surface of the side rubber member 20 of the sidewall portion 10S. According to an embodiment, the two-dimensional code 40 is formed on the surface of the side rubber member 20 in both sidewall portions 10S on both sides in the tire width direction. According to another embodiment, the two-dimensional code is formed on the surface of the side rubber member 20 in one of the sidewall portions 10S.

The two-dimensional code 40 includes a dot pattern including two types of light and shade elements (light elements and shade elements) formed by recesses and protrusions on the surface such that the light and shade elements can be distinguished from each other. The two-dimensional code 40 of the present embodiment is a pattern formed by focusing a laser beam on the surface of the sidewall portion 10S to concentrate the energy thereon to locally heat and burn the side rubber member 20 so that a plurality of minute dot holes 40a (see FIG. 2B) are engraved on the surface. The dot hole 40a is, for example, a conical hole, and has a diameter of, for example, from 0.1 to 1.0 mm and a depth of, for example, from 0.3 to 1.0 mm on the surface of sidewall portions 10S.

As illustrated in FIG. 2A, the two-dimensional code 40 is configured by forming one dot hole 40a (a recess portion) in a unit cell region of a dark region among unit cells that divide the light and shade elements of the two-dimensional code 40. Specifically, the two-dimensional code 40 has a configuration in which dot holes 40a are arranged corresponding to a plurality of rectangular unit cell regions of the same size resulting from division of the code into lattices such that one dot hole 40a forms one unit cell region with a dark light and shade element. In FIG. 2A, the dark region of the unit cell region is represented by a region colored in black.

The two-dimensional code 40 illustrated in FIG. 2A is a QR Code® (registered trade name) and includes a dot pattern region 42 in which a dot pattern is formed using two types of light and shade elements. A blank region 44 surrounded by a pale element similar to the light element of the light and shade element is provided around the dot pattern region 42. The blank region 44 is known as a quiet zone in a QR Code® (registered trade name) and required to read the QR Code® (registered trade name). Preferably, the width of the blank region 44 surrounding the dot pattern region 42 is, for example, four to five times as long as the size of each of the unit cell regions in the dot pattern region 42. For example, the thickness w of the blank region 44 is preferably from 4% to 25% of the maximum dimension among two dimensions in two directions of the rectangular shape of the dot pattern region 42.

Since the two-dimensional code 40 illustrated in FIG. 2A is a QR Code® (registered trade name), the dot pattern region 42 includes a data cell region 42a in which data cells of the QR Code® (registered trade name) are displayed, and segmentation symbol regions 42b in which segmentation symbols are displayed.

Next, the first embodiment and the second embodiment of the side rubber member 20 of the sidewall portion 10S will be described.

### First Embodiment

In the first embodiment, the side rubber member 20 of the sidewall portion 10S is formed from a rubber material including a rubber component of the side rubber member and an anti-aging agent.

Diene rubber is used as the rubber component. Examples of diene rubber include natural rubber (NR), isoprene rubber (IR), butadiene rubber (BR), styrene-butadiene rubber (SBR), acrylonitrile-butadiene rubber (NBR), or a material obtained by blending two or more of these rubber materials.

An amine-based anti-aging agent, preferably a phenylenediamine-based anti-aging agent, is used as the anti-aging agent. Examples of phenylenediamine-based anti-aging agents include p-phenylenediamine anti-aging agents such as N,N′-diphenyl-p-phenylenediamine, n-isopropyl-N′-phenyl-p-phenylenediamine, N,N′-di-2-naphthyl-p-Phenylenediamine, N-cyclohexyl-N′-phenyl-p-phenylenediamine, N-phenyl-N′-(3-methacryloyloxy-2-hydroxypropyl)-p-phenylenediamine, N,N′-bis(1-Methylheptyl)-p-phenylenediamine, N,N′-bis(1,4-dimethylpentyl)-p-phenylenediamine, N,N′-bis(1-ethyl-3-methylpentyl)p-phenylenediamine, N-phenyl-N′-1,3-dimethylbutyl-p-phenylenediamine, phenylhexyl-p-phenylenediamine, and phenyloctyl-p-phenylenediamine. These agents may be used alone or in combination of two or more.

In addition to the rubber component and the anti-aging agent, the rubber material may contain fillers such as carbon black and silica, and additives such as vulcanizing agents, vulcanization accelerators, waxes, plasticizers, zinc oxide, and processing aids.

The rubber material is formed by vulcanizing a rubber composition containing the components described above.

In the first embodiment, 2.7 D<W<9 D is satisfied, in which a recess depth of the recess portion 40a formed on the surface of the sidewall portion 10S so as to form a shade element of the light and shade elements is D mm, and a blending amount of the anti-aging agent with respect to 100 parts by mass of the rubber component is W parts by mass. In this relational expression, D and W each represent a number excluding units. In the present specification, a “recess depth” refers to the depth with respect to the maximum protruding position of the protrusion among the recesses and protrusions, and means, for example, the depth from the surface (the smooth surface facing in the tire width direction) of the sidewall portion 10S, excluding the recess portions 40a. The recess depth can be calculated as the average value of the largest depths of the recess portions 40a as measured for two or more recess portions 40a randomly extracted from the plurality of recess portions 40a formed as the shade elements of the light and shade elements. Since W and D satisfy the above-described relation, as described below, even if the tire 10 is placed in an environment exposed to ultraviolet light and an oxygen atmosphere, it is possible to suppress a decrease in readability of the two-dimensional code 40 while suppressing the occurrence of cracks in the two-dimensional code 40 over a long period.

When the tire rolls in a loaded state and the recess portions deform in response to the rolling, strain of the side rubber member increases, and micro-cracks occur around the recess portions, and the crack tends to progress. When such micro cracks progress, recesses and protrusions are also formed on the surface of the unit cell region without the recess portion, and the degree of shading of the light and shade element (difference in brightness when exposed to light) decreases. Therefore, a reading error of the two-dimensional code is likely to occur.

In the first embodiment, in order to secure the readability of the two-dimensional code over a long period, the side rubber member 20 contains an anti-aging agent as an essential component. However, the anti-aging agent blooms on the surface of the sidewall portion, the anti-aging agent itself is colored by oxidation in air, and the surface of the sidewall portion is susceptible to discoloration (browning). Therefore, when the blending amount of the anti-aging agent is increased, there is a risk that the shading of the light and shade elements is not easily distinguished due to discoloration of the surface of the sidewall portion, and the readability of the two-dimensional code may decrease. Particularly, when the tire is exposed to ultraviolet light and an oxygen atmosphere for a long period, or is stored and left as is, discoloration of the anti-aging agent becomes noticeable, and the readability of the two-dimensional code decreases greatly. Here, in order to increase the degree of shading of the light and shade elements, the depth of the recess portions 40a may be increased. However, if the recess portions 40a are too deep, cracks may easily occur. Cracks progressing in the depth direction of the side rubber member 20 are not preferable from the viewpoint of the durability of the side rubber member 20, and thus the durability of the tire 10.

In the first embodiment, based on the findings that, by setting the blending amount W of the anti-aging agent according to the depth D of the recess portion 40a, it is possible to suppress a decrease in the readability of the two-dimensional code while suppressing the occurrence of cracks in the two-dimensional code for a long period even in an environment in which the tire is exposed to ultraviolet light and an oxygen atmosphere, the blending amount W of the anti-aging agent and the depth D of the recess portion 40a are limited so as to satisfy 2.7 D<W<9 D.

The blending amount W of the anti-aging agent is preferably set to satisfy 3.0 D<W<5.5 D, and more preferably 3.5 D<W<4.5 D. The blending amount W of the anti-aging agent is from 2 to 10 parts by mass with respect to 100 parts by mass of the rubber component, preferably from 2.5 to 6 parts by mass, and more preferably from 3 to 5 parts by mass.

The above-described relational expression is more preferably satisfied when the depth D of the recess portion 40a is from 0.8 to 1 mm.

In addition, when the diameter of the recess portion 40a is from 0.15 to 1.0 mm, the relational expression is preferably satisfied when the diameter is from 0.3 to 0.8 mm. The readability of the two-dimensional code on the wall surface of the recess portion 40a near the opening may also decrease due to discoloration of the blooming anti-aging agent. However, since the diameter of the recess portion 40a is within the above-described range, a region that appears dark can be secured and a decrease in readability can be suppressed.

### Second Embodiment

In the second embodiment, the side rubber member of the sidewall portion 10S is formed from a rubber material containing wax and the rubber component of the side rubber member.

The rubber component is the same as the rubber component of the first embodiment, for example.

A hydrocarbon-based wax that is a waxy solid at room temperature is used for the wax. Examples of the hydrocarbon-based wax include paraffin wax, microcrystalline wax (both compliant to JIS (Japanese Industrial Standard) K2235: 2009).

In addition to the rubber component and the wax, the rubber material may contain fillers such as carbon black and silica, and additives such as vulcanizing agents, vulcanization accelerators, anti-aging agents, plasticizers, zinc oxide, and processing aids.

The rubber material is formed by vulcanizing a rubber composition containing the components described above.

In the second embodiment, 0.6 D<X<3D is satisfied, in which a recess depth of the recess portion 40a formed in the surface of the sidewall portion 10S so as to form a shade element of the light and shade elements is D mm, and a blending amount of the wax with respect to 100 parts by mass of the rubber component is X parts by mass. In this relational expression, D and X each represent a number excluding units. The recess depth is similar to that described in the first embodiment. Since such a relation is satisfied, as described below, even if the tire 10 is placed in a high-temperature environment, it is possible to suppress a decrease in readability of the two-dimensional code 40 while suppressing the occurrence of cracks in the two-dimensional code 40 over a long period.

As described above, since micro-cracks occur around the recess portions in response to rolling of the tire, reading errors of the two-dimensional code is likely to occur.

In the second embodiment, in order to secure the readability of the two-dimensional code over a long period, the side rubber member 20 contains wax as an essential component. However, wax blooms on the surface of the sidewall portion and discolors in white by being decomposed in the air and the surface of the sidewall portion is likely to whiten. Therefore, when the blending amount of the wax is increased, the shading of the light and shade element is not easily distinguished due to whitening of the surface of the sidewall portion, and the readability of the two-dimensional code may decrease. Particularly, when the tire is used or stored as is for a long period in a summer season or in a high-temperature environment (for example, 40 degrees or higher) such as indoor and outdoor environments in high-temperature regions, the blooming amount of the wax increases further, and the whitening of the surface of the sidewall portion becomes significant, and the readability of the two-dimensional code decreases greatly. Here, in order to increase the degree of shading of the light and shade elements, the depth of the recess portions 40a may be increased. However, if the recess portions 40a are too deep, cracks may easily occur.

In the second embodiment, based on the findings that, by setting the blending amount W of the wax according to the depth D of the recess portion 40a, it is possible to suppress a decrease in the readability of the two-dimensional code while suppressing the occurrence of cracks in the two-dimensional code for a long period even in a high-temperature environment, the blending amount X of the wax and the depth D of the recess portion 40a are limited so as to satisfy 0.6 D<X<3D.

The blending amount X of the wax is preferably set to satisfy 1 D<X<2D, and more preferably 1.1 D<X<1.5 D. The blending amount X of the wax is from 0.3 to 4 parts by mass with respect to 100 parts by mass of the rubber component, preferably from 0.8 to 3 parts by mass, and more preferably from 1 to 2 parts by mass.

The above-described relational expression is more preferably satisfied when the depth D is from 0.8 to 1 mm.

Moreover, when the diameter of the recess portion 40a is from 0.15 to 1.0 mm, the relational expression is preferably satisfied when the diameter is from 0.3 to 0.8 mm. The readability of the two-dimensional code on the wall surface of the recess portion 40a near the opening may also decrease due to the whitening of the blooming wax. However, since the diameter of the recess portion 40a is within the above-described range, a region that appears dark can be secured and a decrease in readability can be suppressed.

According to an embodiment of the second embodiment, the wax includes a first wax component and a second wax component each including a plurality of components (hydrocarbon molecules) having different carbon numbers, a carbon number of a component having the highest content among the components of the first wax component (for example, paraffin wax) is less than 40, a carbon number of a component having the highest content among the components of the second wax component (for example, microcrystalline wax) exceeds 40,

(XU/XL)×D is preferably from 0.3 to 2.6, in which a blending amount of the first wax component with respect to 100 parts by mass of the rubber component is XL parts by mass, and a blending amount of the second wax component with respect to 100 parts by mass of the rubber component is XU parts by mass. Any of the wax components have such a carbon number distribution that the larger the difference in carbon number from the component having the highest content, the smaller the carbon number of the component becomes, for example. This distribution may have a distribution in which, in a local range of carbon numbers, the larger the difference in carbon number, the larger the content of the component becomes, or the carbon numbers are equal.

The first wax component has a great effect of suppressing cracks but is likely to bloom and decrease the readability of the two-dimensional code.

The second wax component is less likely to bloom and decrease the readability of the two-dimensional wax compared to the first wax component, but the effect of suppressing cracks is small.

Therefore, in order to suppress a decrease in readability of the two-dimensional code over a long period while suppressing the occurrence of cracks, it is preferable to adjust the content XU of the second wax component with respect to the content XL of the first wax component, that is, adjusting the content ratio XU/XL of the first wax component and the second wax component.

On the other hand, the preferable range of the ratio XU/XL is influenced by the depth D of the recess portions 40a as described below.

When the depth D is large, since the degree of shading of the light and shade element increases, it is not necessary to increase the content of the second wax component which is not likely to bloom and decrease the readability of the two-dimensional code. Therefore, it is possible to secure the content of the first wax component having a great effect of suppressing cracks. Therefore, when the depth D is large, it is preferable to decrease the ratio XU/XL. On the other hand, when the depth D is small, since the degree of shading of the light and shade element decreases, it is preferable to increase the content of the second wax component which is not likely to bloom and decrease the readability of the two-dimensional code to suppress a decrease in readability due to whitening. That is, when the depth D is small, it is preferable to increase the ratio XU/XL.

Furthermore, when the depth D is large, since cracks are likely to occur, it is preferable to increase the content of the first wax component having a great effect of suppressing cracks. That is, the ratio XU/XL is preferably small. On the other hand, when the depth D is small, since cracks are not likely to occur, the content of the first wax component may be small. That is, the ratio XU/XL is preferably large.

In this embodiment, based on the findings that, by limiting the blending ratio XU/XL of the first wax component to the second wax component to a range corresponding to the depth D of the recess portion 40a, it is possible to suppress a decrease in the readability of the two-dimensional code while suppressing the occurrence of cracks for a long period even in a high-temperature environment, the value of (XU/XL)×D is limited to from 0.3 to 2.6.

(XU/XL)×D is preferably from 0.5 to 1.5.

The blending amount XL of the first wax component is preferably from 0.4 to 3 parts by mass, more preferably from 0.5 to 2 parts by mass, and particularly preferably from 0.6 to 1 parts by mass with respect to 100 parts by mass of the rubber component.

The blending amount XU of the second wax component is preferably from 0.1 to 2 parts by mass, more preferably from 0.3 to 1 part by mass, and particularly preferably from 0.4 to 0.8 parts by mass with respect to 100 parts by mass of the rubber component.

It is more preferable that the relational expressions using XU, XL, and D are satisfied when the depth D is from 0.8 to 1 mm.

According to an embodiment, the content XL of the first wax component is preferably larger than the content XU of the second wax component.

Moreover, according to an embodiment, the blending amount X of the wax is preferably larger than the blending amount W of the anti-aging agent.

According to an embodiment of the second embodiment, the rubber material preferably further contains an anti-aging agent, and 2.7 D<W<9 D, in which the blending amount of the anti-aging agent with respect to 100 parts by mass of the rubber component is W parts by mass. In this way, it is possible to strengthen the effect of suppressing a decrease in readability of the two-dimensional code while suppressing the occurrence of cracks in the two-dimensional code for a long period even in an environment where the tire is exposed to ultraviolet light and an oxygen atmosphere. The blending amount W of the anti-aging agent is preferably set to satisfy 3.0 D<W<5.5 D, and more preferably 3.5 D<W<4.5 D.

According to an embodiment of the first embodiment, the rubber material preferably contains wax, and 0.6 D<X<3D, in which the blending amount of the wax with respect to 100 parts by mass of the rubber component is X parts by mass. In this way, it is possible to strengthen the effect of suppressing a decrease in the readability of the two-dimensional code while suppressing the occurrence of cracks in the two-dimensional code over a long period in a high-temperature environment as well as an environment where the tire is exposed to ultraviolet light and an oxygen atmosphere. The blending amount X of the wax is preferably set to satisfy 1 D<X<2D, and more preferably 1.1 D<X<1.5 D. In this case, according to an embodiment, the value of (XU/XL)×D is preferably within the range of from 0.3 to 2.6. In this way, it is possible to suppress a decrease in the readability of the two-dimensional code while suppressing the occurrence of cracks over a longer period even in a high-temperature environment.

According to an embodiment, the two-dimensional code is preferably provided closer to a bead core side of the pneumatic tire than the position in the tire radial direction where the tire width is the largest. The thickness of the sidewall portion 10S on the inner side in the tire radial direction is generally larger than that on the outer side in the tire radial direction at the largest tire width position. Therefore, in the region on the bead core 16 side, deflection or strain that acts on the side rubber member 20 due to rolling of the tire 10 is relatively small, and cracks are less likely to occur on the surface of the two-dimensional code. Therefore, the decrease in readability during long-term use of the tire 10 can be suppressed. The thickness of the portion of the sidewall portion 10S in which the two-dimensional code is provided is, for example, from 2 to 5 mm.

According to an embodiment, the two-dimensional code is preferably provided along the tire radial direction within a height range of from 15 to 50%, and more preferably from 25 to 45%, from an edge on the inner side in the tire radial direction with respect to a height (a tire cross-sectional height) range from the edge on the inner side in the tire radial direction of the tire 10 to an edge on the outer side in the tire radial direction.

### Method for Manufacturing Pneumatic Tire

A method for manufacturing a pneumatic tire according to the present embodiment includes the steps of molding a green tire to produce a vulcanized tire and providing a two-dimensional code on the surface of a sidewall portion of the vulcanized tire. The pneumatic tire is similar to the tire 10 described above. The green tire includes a rubber composition material serving as a side rubber member of the sidewall portion. The side rubber member is similar to the side rubber member of the first embodiment or the second embodiment. The two-dimensional code includes a dot pattern including two types of light and shade elements formed by recesses and protrusions on the surface such that the light and shade elements can be distinguished from each other, and as described above, is formed using an engraving method using a laser beam or another means.

According to the tire obtained according to the present embodiment, when the side rubber member is the side rubber member of the first embodiment, it is possible to suppress a decrease in the readability of the two-dimensional code while suppressing the occurrence of cracks in the two-dimensional code over a long period even in an environment where the tire is exposed to ultraviolet light and an oxygen atmosphere.

Moreover, according to the tire obtained according to the present embodiment, when the side rubber member is the side rubber member of the second embodiment, it is possible to suppress a decrease in the readability of the two-dimensional code while suppressing the occurrence of cracks in the two-dimensional code over a long period even in a high-temperature environment.

### Example, Comparative Example

To confirm the effect of the tire 10, two sets of tires 10 were prepared by engraving a two-dimensional code 40, specifically, a QR Code® (registered trade name), on a sidewall portion 10S formed from various side rubber members illustrated in Tables 1 and 2 to prepare two sets of tires 10. A running test after ozone irradiation was conducted for one set of tires 10, and a running test after storage in a high-temperature environment was conducted for the other set of tires 10. The two-dimensional code 40 was read after the road test was conducted for the respective sets of tires.

### Running Test After Ozone Irradiation

The tire 10 (tire size of 195/65R15 91H) provided with the two-dimensional code 40 was mounted on a 15×6J rim. After the tire 10 was irradiated with ozone at an ozone concentration of 100 pphm, indoor drum running (at a speed of 120 km/hour) based on an FMVSS139-compliant low pressure test (XL: an air pressure of 160 kPa and a load of 100% LI) was conducted for 1.5 hours, with ozone irradiation at the above-described concentration performed at predetermined time intervals.

### Running Test After Storage in High-temperature Environment

After the tire 10 (tire size 195/65R15 91H) provided with the two-dimensional code 40 was stored for 20 days in a warehouse where the room temperature was adjusted to from 60 to 70 degrees, the tire 10 was mounted on a 15×6J rim, and indoor drum running (at a speed of 120 km/hour) based on an FMVSS139-compliant low pressure test (XL: an air pressure of 160 kPa and a load of 100% LI) was conducted for 1.5 hours indoors while adjusting the room temperature to 40 degrees.

Five tires provided with the two-dimensional code 40 were prepared and tested for each of Examples and Comparative Examples, and the readability and the crack resistance were evaluated in the following manner.

### Readability

The two-dimensional code was read using a two-dimensional code reader. Rating A was given when the two-dimensional code 40 was irradiated with illumination light from a predetermined direction and was readable without any problem for all five tires. Rating B was given when, although the two-dimensional code was readable for all five tires, the two-dimensional code was readable for one tire when the irradiation direction of illumination light was changed. Rating C was given when the two-dimensional code was readable for two tires when the irradiation direction of illumination light was changed. Rating D was given when the two-dimensional code was readable for three tires when the irradiation direction of illumination light was changed. Rating E was given when the two-dimensional code was readable for four to five tires when the irradiation direction of illumination light was changed. Rating F was given when the two-dimensional code was not readable for at least one of the five tires. Ratings A to E correspond to passes, and rating F corresponds to a fail.

### Cracking Resistance

The region of the sidewall portion where the two-dimensional code was engraved was observed. Rating A was given when the largest length for all of a predetermined number of cracks extracted randomly among the occurring cracks was 1 mm or smaller. Rating B was given when the number of cracks having the largest length of 1 mm or more was less than 50% of the total number. Rating C was given when the number of cracks having the largest length of 1 mm or more exceeded 50% of the total number. A or B was evaluated that occurrence of cracks could be suppressed, and C was evaluated that occurrence of cracks could not be suppressed.

Table 1 below shows the specifications and evaluation results of tires subjected to running after ozone irradiation.

In Comparative Examples 1 and 2 and Examples 1 to 4, the blending amount of the component of the rubber material excluding the anti-aging agent was a typical blending amount. Phenylenediamine-based anti-aging agents were used as the anti-aging agent. The blending amount of the wax was 1 part by mass in Comparative Examples 1 and 2 and Examples 2 and 4, 0.4 parts by mass in Example 1 and 3.2 parts by mass in Example 3. A wax containing paraffin wax and microcrystalline wax was used, and the XU/XL was 0.2/0.8.

In Comparative Examples 1 and 2 and Examples 1 to 4, the diameter of the dot holes was 0.8 mm.

In Table 1, “Anti-aging agent blending amount W” refers to the blending amount W parts by mass of the anti-aging agent with respect to 100 parts by mass of the rubber component.

TABLE 1

| | Comparative | Example | Example | Example | Example | Comparative |
|---|---|---|---|---|---|---|
| | Example 1 | 1 | 2 | 3 | 4 | Example 2 |
| Depth D (mm) of | 1 | 1 | 1 | 1 | 1 | 1 |
| recess portion | | | | | | |
| Anti-aging agent | 2 | 3 | 3 | 3 | 4 | 10 |
| blending amount | | | | | | |
| W (parts by mass) | | | | | | |
| Readability after | F | E | E | E | D | F |
| ozone irradiation | | | | | | |
| Cracking | C | B | B | B | B | B |
| resistance | | | | | | |

As can be understood from comparison between Comparative Examples 1 and 2 and Examples 1 to 4, when the blending amount W of the anti-aging agent satisfies 2.7 D<W<9 D, it is possible to suppress a decrease in readability of the two-dimensional code while suppressing the occurrence of cracks in the two-dimensional code for a long period even in an environment where the tire is exposed to ultraviolet light and an oxygen atmosphere.

Table 2 below shows the specifications and evaluation results of tires subjected to running after storage in a high-temperature environment.

In Table 2, “wax blending amount X” refers to the blending amount X parts by mass of the wax with respect to 100 parts by mass of the rubber component. “First wax component content XL” refers to the blending amount XL parts by mass of the first wax component with respect to 100 parts by mass of the rubber component. “Second wax component content XU” refers to the blending amount XU parts by mass of the second wax component with respect to 100 parts by mass of the rubber component. Paraffin wax was used for the first wax component, and microcrystalline wax was used for the second wax component.

In Comparative Examples 3 and 4 and Examples 5 to 11, the blending amount of the component of the rubber material excluding the wax and the anti-aging agent was a typical blending amount. Phenylenediamine-based anti-aging agents were used as the anti-aging agent.

In Comparative Examples 3 and 4 and Examples 5 to 11, the diameter of the dot holes was 0.8 mm.

TABLE 2-1

| | Comparative | | | | |
|---|---|---|---|---|---|
| | Example 3 | Example 5 | Example 6 | Example 7 | Example 8 |
| Depth D (mm) of recess portion | 1 | 1 | 1 | 1 | 1 |
| Wax blending amount X (parts | 0.4 | 1 | 1.2 | 1.2 | 1.2 |
| by mass) | | | | | |
| First wax component content XL | 0.4 | 0.8 | 1.0 | 1.0 | 1.0 |
| (parts by mass) | | | | | |
| Second wax component content | — | 0.2 | 0.2 | 0.2 | 0.2 |
| XU (parts by mass) | | | | | |
| (XU/XL) × D | 0 | 0.25 | 0.2 | 0.2 | 0.2 |
| Anti-aging agent blending | 3 | 3 | 2 | 3 | 10 |
| amount W (parts by mass) | | | | | |
| Readability after storage | F | E | D | D | D |
| at high temperature | | | | | |
| Cracking resistance | C | B | B | B | B |
| | Comparative | | | | |
| | Example 4 | Example 9 | Example 10 | Example 11 | |
| Depth D (mm) of recess portion | 1 | 1 | 1 | 1 | |
| Wax blending amount X (parts | 3.2 | 1.2 | 1.2 | 2.0 | |
| by mass) | | | | | |
| First wax component content XL | 3.0 | 0.7 | 0.7 | 0.5 | |
| (parts by mass) | | | | | |
| Second wax component content | 0.2 | 0.5 | 0.5 | 1.5 | |
| XU (parts by mass) | | | | | |
| (XU/XL) × D | 0.067 | 0.71 | 0.71 | 3 | |
| Anti-aging agent blending | 3 | 3 | 4 | 3 | |
| amount W (parts by mass) | | | | | |
| Readability after storage | F | B | A | B | |
| at high temperature | | | | | |

| | | | | |
|---|---|---|---|---|
| Cracking resistance | B | B | A | B |

As can be understood from comparison between Comparative Examples 3 and 4 and Examples 5 to 11, when the wax blending amount X satisfies 0.6 D<X<3D, it is possible to suppress a decrease in the readability of the two-dimensional code while suppressing the occurrence of cracks in the two-dimensional code even in a high-temperature environment.

As can be understood from comparison between Example 9 and Example 10, since the anti-aging agent was blended into the side rubber member 20 so that the blending amount W satisfies 3.0 D<W<5.5 D, an unexpected effect of strengthening the effect of improving the readability over a long period even in a high-temperature environment was obtained.

The foregoing has been a detailed description of the pneumatic tire according to embodiments of the present technology. However, the pneumatic tire according to an embodiment of the present technology is not limited to the above embodiments or examples and may of course be enhanced or modified in various ways within the scope of the present technology.

1. A pneumatic tire, comprising:
a pair of sidewall portions that sandwich a tread portion from both sides in a tire width direction, the tread portion extending in a tire circumferential direction and forming an annular shape,
a two-dimensional code, in which a dot pattern is formed using two types of light and shade elements that are formed by recesses and protrusions such that the light and shade elements can be distinguished from each other, being engraved on a surface of a side rubber member of the pair of sidewall portions,
the side rubber member being formed from a rubber material containing a rubber component and an anti-aging agent, and
2.7 D<W<9 D being satisfied, in which a recess depth of a recess portion among the recesses and protrusions formed on the surface of the side rubber member so as to form shade elements of the light and shade elements is D mm, and a blending amount of the anti-aging agent with respect to 100 parts by mass of the rubber component is W parts by mass.

2. A pneumatic tire, comprising:
a pair of sidewall portions that sandwich a tread portion from both sides in a tire width direction, the tread portion extending in a tire circumferential direction and forming an annular shape,
a two-dimensional code, in which a dot pattern is formed using two types of light and shade elements that are formed by recesses and protrusions such that the light and shade elements can be distinguished from each other, being engraved on a surface of a side rubber member of the pair of sidewall portions,
the side rubber member being formed from a rubber material containing a rubber component and a wax, and
0.6 D<X<3D being satisfied, in which a recess depth of a recess portion among the recesses and protrusions formed on the surface of the side rubber member so as to form shade elements of the light and shade elements is D mm, and a blending amount of the wax with respect to 100 parts by mass of the rubber component is X parts by mass.

3. The pneumatic tire according to claim 2, wherein
the wax comprises a first wax component and a second wax component each comprising a plurality of components having different carbon numbers,
a carbon number of a component having a highest content among the components of the first wax component is less than 40,
a carbon number of a component having a highest content among the components of the second wax component exceeds 40, and
(XU/XL)×D is from 0.3 to 2.6, in which a blending amount of the first wax component with respect to 100 parts by mass of the rubber component is XL parts by mass, and a blending amount of the second wax component with respect to 100 parts by mass of the rubber component is XU parts by mass.

4. The pneumatic tire according to claim 3, wherein a content XL of the first wax component is larger than a content XU of the second wax component.

5. The pneumatic tire according to claim 1, wherein the recess depth is from 0.8 to 1.0 mm.

6. The pneumatic tire according to claim 1, wherein an opening length at an opening end of the recess portion open to the surface of the side rubber member is from 0.3 to 1.0 mm.

7. The pneumatic tire according to claim 1, wherein the two-dimensional code is provided closer to a bead core side of the pneumatic tire than a position in the tire radial direction where the tire width is the largest.

8. The pneumatic tire according to claim 4, wherein the recess depth is from 0.8 to 1.0 mm.

9. The pneumatic tire according to claim 8, wherein an opening length at an opening end of the recess portion open to the surface of the side rubber member is from 0.3 to 1.0 mm.

10. The pneumatic tire according to claim 9, wherein the two-dimensional code is provided closer to a bead core side of the pneumatic tire than a position in the tire radial direction where the tire width is the largest.
